(19) United States
(12) Patent Application Publication
(10) Pub. No.: US 2005/0240442 A1
(43) Pub. Date: Oct. 27, 2005

(54) Fraud-resistant prescription drug compliance system with resuable discount means and third party adjudication

(76) Inventor: Joshua Lapsker, Christ Church (BB)

Correspondence Address: KLAUBER & JACKSON, 411 HACKENSACK AVENUE, HACKENSACK, NJ, 07601, US

(21) Appl. No.: 11/140,257

(22) Filed: May 27, 2005

Related U.S. Application Data
(63) Continuation-in-part of application No. 10/865,491, filed on Jun. 10, 2004.
(63) Continuation-in-part of application No. 10/785,930, filed on Feb. 24, 2004.

(51) Int. Cl. G06F 17/60; G04B 47/00

(52) U.S. Cl. 705/2

(57) ABSTRACT

A prescription drug compliance and reusable discount system having enhanced fraud prevention capability for sponsors that provides reminders and offers incentives to patients to continue the taking of prescription medications.

### CROSS-REFERENCE TO RELATED APPLICATIONS

This application is a continuation-in-part of co-pending application Ser. No. 10/865,491 filed Jun. 10, 2004, which in turn is a continuation-in-part of co-pending application Ser. No. 10/785,930 filed Feb. 24, 2004, and the entire disclosure of all applications are incorporated herein in their entirety.

### DESCRIPTION

### BACKGROUND AND SUMMARY OF THE INVENTION

The dynamic of patients not taking prescriptions as required (non-compliance) has become a major health problem. This dynamic may occur because people who may be only partially insured (e.g., the elderly), or wholly uninsured (e.g., lower income populations), or those who are too busy or forgetful in their daily lives to procure medications, are prone to discontinue or not to fill prescriptions as directed. Non-compliance in prescription drug taking is putting an enormous strain on the health care system today. Moreover, the most pressing aspect of non-compliance is reflected in the fact that compliance drops off dramatically when it comes time to refill a prescription. This represents an unhealthy reality that costs both employers, insurance companies, and society at large greatly over time.

Even for pharmaceutical companies, non-compliance is a source concern, given that, as prescription drugs become increasingly expensive, and as government and employer funded coverage for such drug plans becomes less comprehensive, compliance or lack thereof, directly affects their bottom line because ultimately less prescriptions being filled and/or refilled means less of their product is sold.

As such, assurance of long-term compliance in the taking of prescription drugs is quite problematic. Prior art systems offered by insurers and the like do not address the root of the problem in non-compliance, which is motivation, something which is often compromised by ongoing financial concerns associated with prescription fulfillment. While these systems may attempt to provide some form of compliance, none actually encourage or motivate a patient through financial incentives to comply with a drug prescription on a sustainable basis.

In some limited cases, pharmaceutical companies have been attempting to rectify the problem of non-compliance by offering a simple coupon redeemable for their own brand name prescription medication. This approach has its own problems in that it is administratively burdensome to both physicians and point of sale pharmacists (thereby limiting participation on a wider scale, and undercutting any putative benefits for patients). Furthermore, this approach is often misused by patients and/or dispensaries who may redeem such coupons for non-existent purchases, or purchases of competing brand medications.

Despite the existence of such fraud, no system exists to encourage compliance in a fraud-resistant manner. No known compliance system from pharmaceutical sponsors (or others) has provided for an incentive means that would encourage a given prescription medication to be taken by patients yet is fraud-resistant. As such, if a fraud-resistant means were developed to incentivize patients to take a prescribed medication, then sponsors of a particular brand of medication would be more disposed toward offering incentive-based vehicles that would incentivize patients and foster wider levels of compliance on a long term basis.

To this end, the present invention relates to the purchasing and taking of prescription drugs through an incentive-based compliance system that is fraud-resistant. The system uses a reusable discount means such as a card or voucher and incorporates a third party adjudicator for monitoring the participation of a patient who has been incentivized by the prospect of ongoing (e.g., multiple use) discounts for a given prescription. The third party adjudicator ensures that all participants or actors within the given sponsored incentivized participation are neither victims of, nor perpetrators of, fraudulent schemes against the sponsor.

### BRIEF DESCRIPTION OF THE DRAWINGS

FIG. 1 is a depiction of an exemplary reusable discount means and solicitation/sign up means contemplated by the inventive system;

FIG. 2 is a flowchart detailing an exemplary process that might be employed in executing the inventive method and functions of the system; and

FIG. 3 is a general rendering of an exemplary process relationship between the major connected elements of the inventive reusable discount card and prescription drug compliance system.

### DETAILED DESCRIPTION OF THE DRAWINGS AND PREFERRED EMBODIMENTS

In its broadest aspect, the present invention provides for a fraud resistant prescription drug compliance and discount payment system and a method with third party adjudication, having at least one reusable discount means having an identification number, a patient status and information data processor means for receiving from a patient a patient consent and information associated with the patient, and also for associating and activating an identification number associated with a reusable discount means and the patient, and a redemption means for receiving from a third party adjudicator information pertaining to a given adjudicated prescription transaction that has been validated as a legitimate prescription transaction based on the third party adjudicator information (so as to reduce fraud) as received by the third party adjudicator and as adjudicated and screened according to defined business rules, and a compensation means, associated with the redemption means, for compensating at least one third party based upon the third party adjudicator information for the legitimate prescription transaction in accordance with terms set forth by the reusable discount means. Related embodiments will further include a compliance means for ensuring a continuing of a prescription compliance of each said patient (including a further means for collecting or aggregating information representing medical purposes such as a doctor-specific feedback on patients.

The above is effectuated through the referenced third party adjudication information, as provided by the third party adjudicator to the redemption processing entity so as to ensure prescription drug compliance through the offering of fraud-resistant incentives. Accordingly, the third party adjudicator will work coordinatively with the above described redemption processing entity, under a system and method broadly comprising a means for receiving information relating to the patient and the prescription transaction, a means for evaluating the patient and prescription transaction information so as to adjudicate patient and prescription eligibility according to defined business rules, a means for both attaching a legitimate flag to a given transaction where it satisfies all conditions of the defined business rules, and rejecting a given transaction where it does not satisfy all said conditions of the defined business rules; and a means for reporting the results of the aforementioned steps as adjudicated information to additional parties, including at least a pharmacy involved in said given transaction and the redemption processing entity involved in the given transaction.

Accordingly, the third party adjudicator will, in one embodiment, further have a means for attaching a legitimate flag to a given transaction where it satisfy all conditions of the defined business rules, and rejecting a given transaction where it does not satisfy all said conditions of the defined business rules further includes a means for assessing whether a given transaction will satisfy said defined business rules by providing a query structure that determines whether the given transaction satisfies each of the following indicia including: indication of an activated identification number, indication of a sponsored medication and attendant regimen thereof, indication of a sponsorable patient, and indication of compliance with applicable laws. In one embodiment, the third party system further comprises a means for receiving compensation from the redemption processing entity, and distributing compensation to at least one additional party (e.g., pharmacy, patient-based upon the adjudicated information).

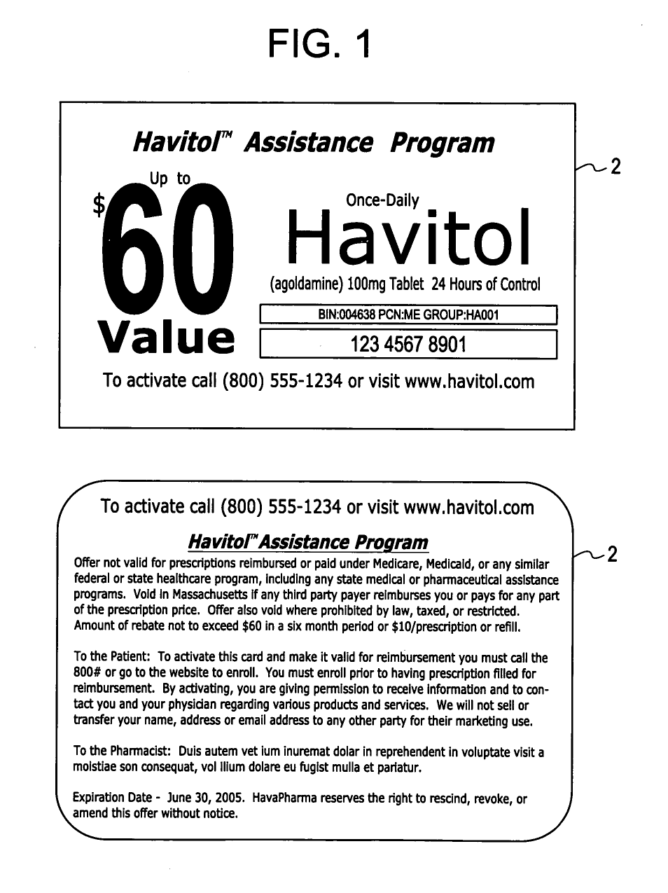

Turning, then to the figures, FIG. 1 depicts a reusable discount means such as a card or voucher. FIG. 1 depicts an exemplary card or voucher (which may be offered by itself or in tandem with a solicitation means 20 described hereafter) acting as a contact gateway, and may include a contact point such as a toll free number or website for signing up (provided for those who might not wish to sign up by mail). Many variants of the reusable discount means 2 and solicitation may be envisioned, and hence, many approaches to signing up may be utilized. According to one embodiment, reusable discount means 2 will be a standard plastic (or paper) card, and will have printed product information, discount information, and a unique identifier and optional transaction code means (embodied by a bar code, smart chip, and/or magnetic stripe, etc.), but may be most preferably simply embossed on the card. Unique identifier and optional transaction code means such as an identification number will be one of the preferred ways of activating and tracking the discount card usage. Where the identification number is, in an alternative embodiment, printed with a bar code, such activation and subsequent card usage may be tracked by the use of a common bar code scanner device well known in the art of retailing and cash register technologies. However, in order to facilitate widespread usage of the inventive system through existing pharmacy networks, the numeric representation may be simply typed or otherwise entered into an existing pharmacy system for entering and processing secondary insurance-type information for prescriptions.

Accordingly, where a patient 8 consents to enrolling in the discount compliance program, his name, address, indication of consent, preferred means of receiving future reminders, and other information can be received through mail, email, web page input, or via phone, by an opt-in center 9 (typically a call center or equivalent), forwarded via web-enabled transmission or equivalent into a database at a redemption processing entity 12 (either through manual data entry input, or through form-based scanning as known in the art). At this point, the opt-in-center 9 can utilize certain screening rules (such as prior use of the discount means, government assistance, etc.) to screen out patients who the sponsor may not want to participate, or who may be legally ineligible to participate. The solicitation/sign up portion will therefore, typically have at least one (confidential) identification number that has been recorded at the time of printing for identifying the type of prescription drug (and refill specifics as needed) and will aid in activating and in correlating a given patient when processed within the system. In a more particular embodiment, this identification number will be the above-referenced numeric representation, and will be printed or embossed directly on the card or voucher. In an especially preferred embodiment, the inventive system may have two unique identification numbers (a pharmacy control number “PCN” and a bank identification number “BIN” printed at least on the reusable discount means 2 (e.g., the card or voucher) and possibly on the solicitation/sign up portion 3 so that the identification numbers contained therein can function as a confidential tracking number for both accounting and medical purposes.

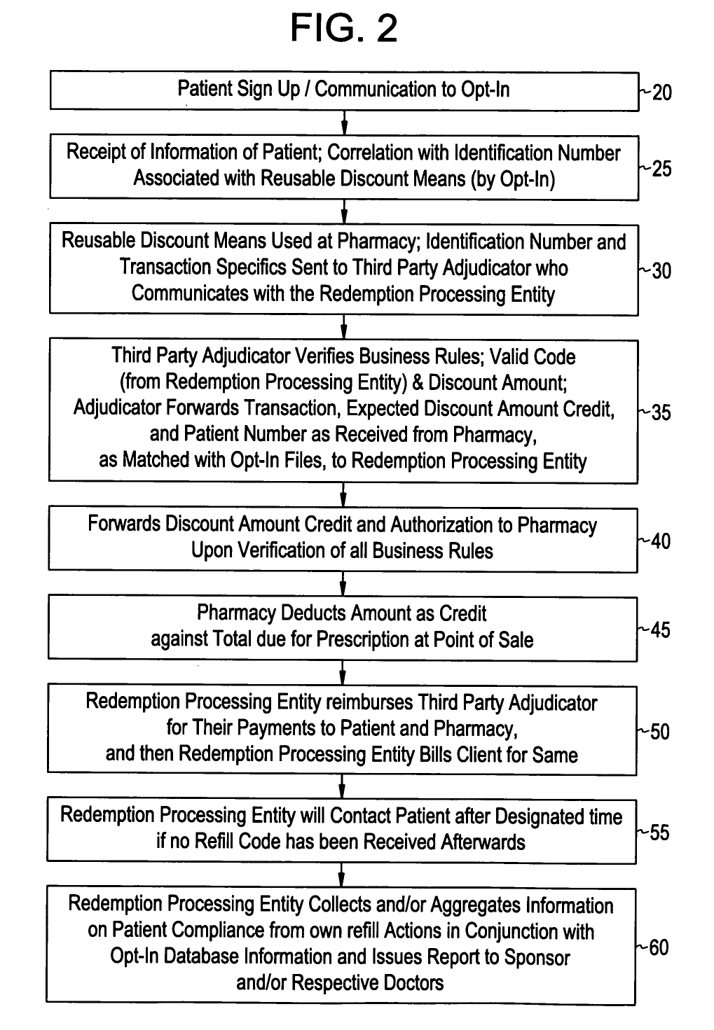

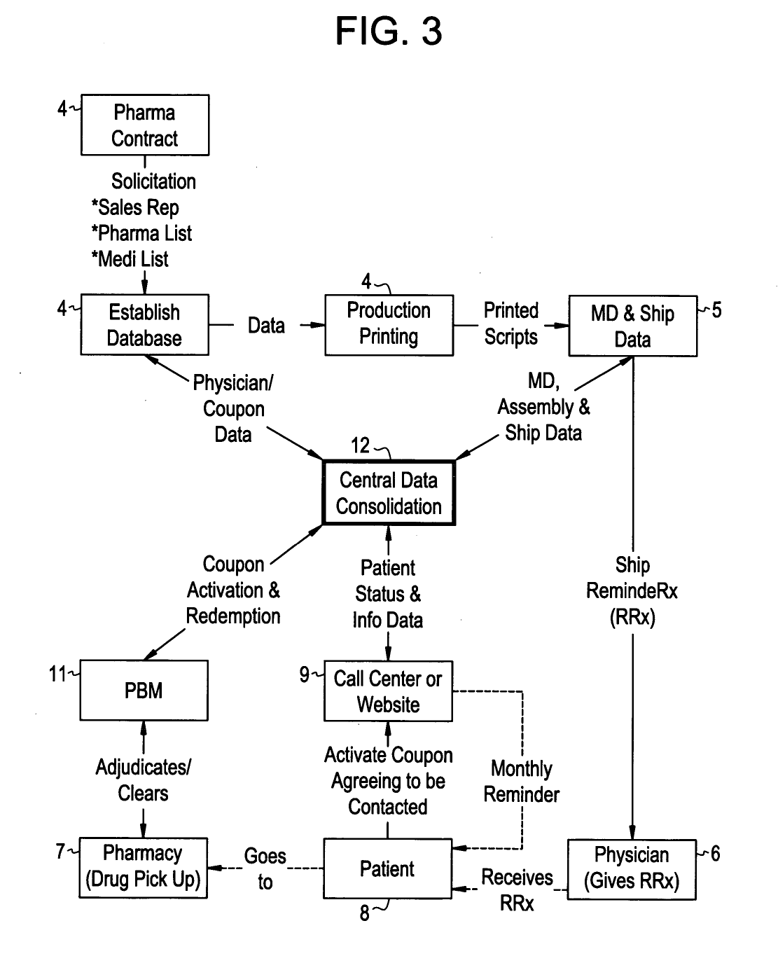

With general reference to both FIGS. 2 and 3, when the card or voucher is presented at the pharmacy 7, the system will be providing a way of correlating information received at the solicitation/sign up time with the card usage thereafter. Having confirmed earlier the activation of the card and identification number through the screening rules described above at activation, additional business rules will thereafter confirm that the pre-screened patient is using the discount card or voucher in accordance with the several conditions described herein that prevent a non-sponsored medication, wrong quantity/regimen, etc., from forming the basis for a fraudulent usage of the discount as sponsored.

Usage by patients 8 at pharmacy 7, will, as referenced above, provide a way for the sponsors or providers 4, 5 so as to be able to correlate the entirety of patient information received by the redemption processing entity 12 as received via the opt-in center 9 and through the identification number 5, when the third party adjudicator 11 receives from pharmacy 7 the identification number that will accompany the transmission of the occurrence of a prescription transaction being fulfilled at pharmacy 7 by patient 8. Storing the information at opt-in center 9 at the time of opt-in allows pharmacy 7 to participate in the reimbursement program without transmitting private patient health information that might be prohibited under HIPAA and other privacy regulations.

Thus, FIG. 3 shows the major elements of the system. Ideally, the pharmacy 7 and redemption processing entity 12 and the third party adjudicator 11 will be connected to each other via some form of secure network means, such as the internet, where they can communicate in real time as needed, or where they can just send coded transaction data and reimbursement information data to each other as needed through regularized, instant transmission of transaction data. As for the patient, where he has indicated a preference for internet (email) or phone notification, there will be an internet, cable, phone, or other type connection with the patient and the opt-in-center 9 for reminding the patient. Ideally, the redemption processing entity 12 with prompt the opt-in-center 9 to do certain things at the appropriate time, such as sending a welcome package at startup, reminder x number of days before a prescription is due to be refilled (plus or minus any samples received at the outset), etc. This reminder program may continue as long as needed, but in most cases will be 3, 6 or 12 months based on the length of the program.

By way of more specific illustration, a preferred process within the inventive system might begin with the patient's doctor writing a prescription, and at that time the doctor would hand him the sign up/consent 3 and the attached reusable discount means 2. The patient's doctor would normally write the prescription containing the following information: patient's name, doctor's name, drug name indicating whether or not generic replacement is acceptable, and prescription length/refill availability. Patient 8, ideally motivated by the idea of incentives (e.g., preferably discounts as stated herein), together with his physician's recommendation, will therefore be inclined to participate. The opt-in center 9 would receive the completed solicitation sign up information via phone, e-mail, mail, internet for the first filling of a given prescription, and would forward the same to the redemption processing entity 12. The completed solicitation sign up means 3 has a confidential identification number, described above, that is identical to the one on the reusable discount card 2 and can be used to track filling of prescription and correlate the related patient information for each use of the reusable discount means 2 if received by mail. The redemption processing entity 12 would have activation and compliance information relating to card/number activation for a given patient, and would be able to ascertain (subsequent) compliance of the patient 8 as needed.

The third party adjudicator 11 would have defined business rules relating to minimum requirements (such as brand name matching, quantity matching, disallowance of government subsidized patents and other/or legal requirements), and would be able to receive a request to fulfill an incentive (e.g., permitted point of sale discount to a patient) for a given prescription fulfillment transaction from the dispensing pharmacy 7. The identification number and any other prescription-related information from the reusable discount means 2 can be formed as a time and date-stamped data packet, and can be sent to the third party adjudicator 11 via a network, instantly through an established communication link such as satellite, frame relay, PSTN, LAN or WAN or POTS. In an especially preferred embodiment, a communication link between the third party adjudicator 11 and the pharmacy 7 would be a dedicated T2 type or better, or satellite connection. The third party adjudicator 11 could then download the confidential identification number in real time. The following data might then be received at the third party adjudicator 11: patient prescription number; dosage amount/regimen; drug name/type; government reimbursement, total cost minus proposed discount, and date. The third party adjudicator 11 will then utilize the above described benefits to ensure that the proposed transaction is legitimate (e.g., that it satisfies all of the above described business rules, such as the transaction comporting with all applicable laws, such as the final cost not being less than zero dollars, that the patient is not being government subsidized, that the prescription is the right name brand and quantity as required by the sponsor of the discount program, etc.) so that the proposed discount may be processed. Once determined to be legitimate, it is flagged as such, and then passed on to the redemption processing entity 12 who will then process this information, along with its own confirmed information of a proper activation of a card/number, and will allow the transaction to proceed so that the third party adjudicator 11 may permit the point of sale discount to the patient, and simultaneously reimburse the pharmacy 7, after which the redemption processing entity 12 will reimburse the third party adjudicator. If the transaction fails to satisfy any one of the above-described business rules, then the transaction is not flagged, and is rejected directly back to the pharmacy 7.

From the adjudicated information received in each transaction, the redemption processing entity 12 would be the central repository of all patient, doctor, prescription, and/or insurance, bar code or magnetic strip encoded data. Enough information as is needed for identification (e.g., a reliable, reasonably private indicators such as birth date, etc.) would be shared with the third party adjudicator 11 as appropriate so as to more effectively verify the legitimacy of a given drug specific discount transactions. Third party adjudicator 11 would therefore verify that a given card is only being used for one patient's medication, in conjunction with the eligibility processing by the redemption processing entity 12 who can assist in determining that the card/number has not expired or exceeded the maximum allowable multiple discounts. When provided as such, the third party adjudicator 11, as a disinterested mediator with no business relationship to any given pharmacy (or patient) will be in a position to match up or verify that the correct prescription brand is being dispensed by the pharmacy to the correct eligible patient.

Thus, in FIG. 2, the flow diagram illustrates one theory of operation of the inventive system. Patient sign-up begins at 20 followed thereafter by the prompting of receipt and correlation of information at 25, which leads to card (reusable discount means) activation at 30, as logistically accomplished as described above. Also detailed above, once a patient has filled an initial prescription, the patient will have already signed up and the reusable discount means 2 will have been initialized through the web, e-mail, regular mail, or by having called opt-in center 9 directly. In one embodiment, any given pharmacy 7 will be able to communicate with the third party adjudicator 11 through phone, or in one embodiment through a network/internet connection, as described above, where simple software, as known in the art for retailing, has been installed at a pharmacy 7. In a preferred embodiment, however, pharmacy 7 would not need to install such software, as the confidential identification code may simply be transmitted to redemption processing entity 11 by manual entry of the numerical representation or confidential identification code into currently existing pharmacy based systems for fulfilling prescriptions with secondary insurer benefits. Such simplicity of implementation and operation, in addition to the monetary benefits described hereafter for a pharmacy 7 would help solicit participation of a given pharmacy 7 within the inventive system.

It can then be determined utilizing the previously received prescription refill information detailed above by automated processing at steps 30, 35 at third party adjudicator 11, whether a discount is legitimate according to the above-described business rules, as received by the networked pharmacy 7. According to one preferred embodiment, when a patient comes to fill or refill a prescription, then the pharmacy 7 will be able to input the identification number by either manually typing into a computer the identification number, or by swiping the reusable discount means 2 at a swipe terminal (not depicted) much like swipe technology that is currently well known in the art of credit card processing. As detailed above, a magnetic strip is preferably provided on reusable discount means 2 so that it can be read by the swipe terminal, such that the given transaction can be immediately transmitted for automated processing via the third party adjudicator 11, so that thereafter, the predetermined discount stated on the given card (the amount and duration of which is necessarily different for each type of medication, depending on manufacturer terms is ideally encoded within the identification number on the card so that it can be immediately applied) is sent at step 40 from redemption processing entity 12, via third party adjudicator 11, to the patient 8. Except in cases of Medicare patients, or where otherwise prohibited by law, third party adjudicator 11 will flag a transaction 2 as being legitimate, and forward it to the redemption processing entity 12 who will apply the discount immediately at time of payment at 45 through an electronic credit authorized through to the pharmacy 7. The third party adjudicator 11 will then pay pharmacy 7 a reimbursement step 50, for the point of sale discount at step 45, plus any agreed upon participation fee for legitimate prescriptions (e.g. only those brands and quantities which are sponsored). The participation fee will ultimately be born by the pharmaceutical client of the redemption processing entity 12, who will utilize and reimburse the third party adjudicator 11 for monitoring and effectuating the actual execution of payments and reimbursements with patient 8 and pharmacy 7.

In one alternative embodiment, instead of in-person presentation at a pharmacy, the present invention provides for the card or voucher of the reusable discount means 2 to be used over the phone or through the mail as is currently popular when filling prescriptions. In such cases, rather than utilizing a scan, the confidential identification number, or other number such as the a bar code number or other serial number that represents the confidential identification number, may be written down on a form for mailing, input on a web page form on the internet for transmission, or may be communicated over the phone to a live representative or to a voice activated automated system. The amount of discount could be accounted for by the third party adjudicator 11, just as if presented during the in-person presentation at a pharmacy 7 when payment is required during the transaction.

Subsequently, if the refill has not been processed according to a set of terms associated with a patients particular prescription need, (e.g., within the refill time period), then an automated reminder 40 can be sent from the associated reminder processor 9 to patient 8 via the means designated by the patient originally on the solicitation/sign up portion 3. The automated reminder, as suggested earlier, could be conveyed at 55 in any one (or several) types of means preferred by the patient. If the user does not refill the prescription after two (2) reminder attempts by the associated reminder processor 12, the primary care giver may be notified, if required by the insurer. Although the primary motivation is based on the discounts applied, this action would additionally motivate the user to be in compliance. Dates of non-compliance, as well as care giver notification might, in certain embodiments, all be recorded in a database at associated reminder processor 12 and/or at redemption processing entity 12. Thereafter, information regarding patient compliance may be collected or aggregated at 60 to form broad pictures of compliance by groupings of patients. Such compliance might then be given to physician 6 as doctor-specific feedback or other type of an informational representation of doctors patient base compliance. Provision of such information in this manner would not only be HIPAA-compliant, but would also be useful to physicians 6 in improving or understanding their own practice and/or patient base, as well as for insurance and/or pharmaceutical business purposes.

This application—taken as a whole with the specification, claims, abstract, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure. Modification of this method and apparatus can become clear to a person having ordinary skill in this particular art; all such modifications are clearly covered by this disclosure.

1. A prescription drug compliance and discount payment system comprising:
(a) a patient status and information data processor means for receiving a patient consent and information associated with said patient from a patient, and for associating and activating an identification number associated with a reusable discount means and said patient; and
(b) a redemption means for receiving from a third party adjudicator information pertaining to a given adjudicated prescription transaction that has been validated as a legitimate prescription transaction based on said third party adjudicator information by said third party adjudicator, and a compensation means, associated with said redemption means, for compensating at least one third party based upon said third party adjudicator information for said legitimate prescription transaction in accordance with terms set forth by said reusable discount means.

2. The system of claim 1, further comprising: a compliance means for ensuring a continuing of a prescription compliance of each said patient.

3. The system of claim 2, wherein said compensating of at least one third party for said legitimate prescription transaction in accordance with terms set forth by said reusable discount means further includes a point of sale discount to said patient, and a monetary payment to a pharmacy in response to provision of said point of sale discount to said patient.

4. The system of claim 3, wherein said compensation means for compensating at least one third party based upon said third party adjudicator information for said legitimate prescription transaction in accordance with terms set forth by said reusable discount means, effectuates said compensating such that any patient discount given complies with applicable laws pertaining to prescription sales.

5. The system of claim 4, wherein said identification number allows collection of information representing said prescription compliance of at least one patient for medical purposes.

6. The system of claim 5, wherein said medical purposes includes a doctor-specific feedback on patients.

7. A method of ensuring prescription drug compliance by offering fraud-resistant incentives, said method comprising:
(a) receiving a patient consent and information associated with said patient from a patient;
(b) associating and activating an identification number associated with a reusable discount means and said patient;
(c) receiving from a third party adjudicator information pertaining to a given adjudicated prescription transaction that has been validated as a legitimate prescription transaction based on said third party adjudicator information by said third party adjudicator; and
(d) compensating at least one third party based upon said third party adjudicator information for said legitimate prescription transaction in accordance with terms set forth by said reusable discount means.

8. The method of claim 7 further comprising the step of: ensuring a continuing of a prescription compliance of each said patient.

9. The method of claim 8, further comprising the step of providing a point of sale discount to said patient, and a monetary payment to a pharmacy in response to provision of said point of sale discount to said patient.

10. The method of claim 9, further comprising the step of effectuating said step of compensating in such a way that any patient discount given complies with applicable laws pertaining to prescription sales.

11. The method of claim 10, further comprising the step of collecting information representing said prescription compliance of at least one patient for medical purposes.

12. The method of claim 10, said step of collecting information further comprising the provision of a doctor-specific feedback on patients.

13. The method of claim 12, wherein said step of collecting further includes the step of aggregating said patient data for delivery to a doctor associated with the patient data.

14. A system of adjudicating reusable discount means transactions comprising:
(a) a means for receiving information relating to a patient and a prescription transaction;
(b) a means for evaluating said patient and prescription transaction information so as to adjudicate patient and prescription eligibility according to defined business rules;
(c) a means for attaching a legitimate flag to a given transaction where it satisfies all conditions of said defined business rules, and rejecting a given transaction where it does not satisfy all said conditions of said defined business rules; and
(d) a means for reporting the results of steps (b) and (c) as adjudicated information to additional parties, including at least a pharmacy involved in said given transaction and a redemption processing entity involved in said given transaction.

15. The system of claim 14 wherein said means for attaching a legitimate flag to a given transaction where it satisfy all conditions of said defined business rules, and rejecting a given transaction where it does not satisfy all said conditions of said defined business rules further includes a means for assessing whether a given transaction will satisfy said defined business rules by providing a query structure that determines whether the given transaction satisfies each of the following indicia including: indication of an activated identification number, indication of a sponsored medication, indication of a sponsorable patient, and indication of compliance with applicable laws.

16. The system of claim 15 further comprising a means for receiving said compensation from a redemption processing entity, and distributing compensation to at least one said additional party based upon said adjudicated information.
